(19) United States
(12) Patent Application Publication
(10) Pub. No.: US 2017/0244166 A1
(43) Pub. Date: Aug. 24, 2017

(54) DUAL RESONATOR ANTENNAS

(71) Applicant: QUALCOMM Incorporated, San Diego, CA (US)

(72) Inventors: Yuandan DONG, Irvine, CA (US); Jatupum JENWATANAVET, San Diego, CA (US)

(21) Appl. No.: 15/143,313

(22) Filed: Apr. 29, 2016

Related U.S. Application Data
(60) Provisional application No. 62/298,904, filed on Feb. 23, 2016.

(51) Int. Cl. H01Q 5/50; H01Q 7/00; H01Q 1/24; H01Q 1/48

(52) U.S. Cl. CPC H01Q 5/50; H01Q 1/48; H01Q 7/005; H01Q 1/243

(57) ABSTRACT

A dual resonator antenna device may include a ground plane positioned adjacent a substrate and may include a first aperture and a second aperture exposing the substrate therethrough. The device may also include an antenna feed positioned in the first aperture. A monopole resonator is coupled to the antenna feed and has a portion near at least one edge of the substrate proximate the second aperture and another portion near the substrate and the ground plane in a direction perpendicular to the ground plane. The device may also include a tunable loop resonator within the first aperture and coupled to the antenna feed and the ground plane.

### CROSS-REFERENCE TO RELATED APPLICATION

The present application claims the benefit of U.S. Provisional Patent Application No. 62/298,904, filed on Feb. 23, 2016, and titled “DUAL RESONATOR ANTENNAS,” the disclosure of which is expressly incorporated by reference herein in its entirety.

### BACKGROUND

Field

The present disclosure relates generally to wireless communication devices. More specifically, the present disclosure includes aspects related to wireless communication device antennas.

Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, 3GPP2 Ultra Mobile Broadband (UMB) systems, and orthogonal frequency division multiple access (OFDMA) systems.

In a communication system, a transmitter may process (e.g., encode and modulate) data. The transmitter may further condition (e.g., convert to analog, filter, frequency up-convert, and amplify) the data to generate an output radio frequency (RF) signal. The transmitter may then transmit the output RF signal via a communication channel to a receiver. The receiver may receive the transmitted RF signal and perform the complementary processing on the received RF signal. The receiver may condition (e.g., amplify, frequency down-convert, filter, and digitize) the received RF signal to obtain input samples. The receiver may further process (e.g., demodulate and decode) the input samples to recover the transmitted data.

Wireless communication devices, which may include one or more transmitters and/or receivers, may require one or more antennas capable of transmitting and receiving RF signals over a variety of wireless networks and associated bandwidths.

### SUMMARY

In an aspect of the present disclosure, a device is presented. The device includes a ground plane positioned adjacent a substrate. The ground plane includes a first aperture and a second aperture exposing the substrate therethrough. The device also includes an antenna feed positioned in the first aperture. The device further includes a monopole resonator coupled to the antenna feed. The monopole resonator has a portion positioned adjacent the substrate proximate the second aperture and another portion near the substrate and the ground plane in a direction perpendicular to the ground plane. Furthermore, the device includes a tunable loop resonator within the first aperture and coupled to the antenna feed and the ground plane.

In another aspect of the present disclosure, a method is presented. the method includes resonating a monopole resonator for operation in a high-band. The method also includes resonating a tunable loop resonator including a ground plane for operation in at least one of a low-band or the high-band.

In yet another aspect of the present disclosure, a device is presented. The device includes means for resonating a monopole resonator for operation in a high-band. The device also includes means for resonating a tunable loop resonator including a ground plane for operation in at least one of a low-band or the high-band.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 shows a wireless device communicating with a wireless system, according to an exemplary embodiment of the present disclosure.

FIG. 2 shows a block diagram of the wireless device in FIG. 1.

FIG. 3 illustrates an antenna device, in accordance with an embodiment of the present disclosure.

FIG. 4 illustrates an antenna device including a monopole resonator and a tunable loop resonator, according to an embodiment of the present disclosure.

FIG. 5 illustrates a monopole resonator of an antenna device, in accordance with an embodiment of the present disclosure.

FIG. 6 illustrates a tunable loop resonator of an antenna device, in accordance with an embodiment of the present disclosure.

FIG. 7 is another illustration of an antenna device including a monopole resonator and a tunable loop resonator, according to an embodiment of the present disclosure.

FIGS. 8A-8E depict tuning circuits for tuning a tunable loop resonator, according to an embodiment of the present disclosure.

FIG. 9 is a flowchart depicting a method, in accordance with an exemplary embodiment of the present disclosure.

FIG. 10 shows an antenna device, according to an exemplary embodiment of the present disclosure.

### DETAILED DESCRIPTION

The detailed description set forth below in connection with the appended drawings is intended as a description of exemplary embodiments and is not intended to represent the only embodiments. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments. It will be apparent to those skilled in the art that the exemplary embodiments may be practiced without these specific details. In some instances, well-known structures and devices are shown in block diagram form in order to avoid obscuring the novelty of the exemplary embodiments presented herein.

Traditional Long Term Evolution/Wireless Wide Area Network (LTE/WWAN) antennas include a long antenna trace due to a relatively large wavelength in low-band. Due to limited antenna volume, an antenna trace may be substantially bent to generate low-band resonance, making an antenna structure and fabrication very complicated. Further, it may be difficult for tunable LTE/WWAN antennas, whether impedance or aperture tunable, to provide independent, or stable high-band response while tuning the low-band, resulting in difficulty for carrier aggregation.

Due to the increase of battery size, deployed sensors, antennas, and other components, available space for LTE/WWAN antennas is becoming smaller and smaller. Ground clearance is also limited. The ground clearance is an area (e.g., an area of a substrate (e.g., printed circuit board (PCB)) below the antenna not having the ground plane. The ground clearance may be created by removing a portion of the ground plane below the antenna thus producing an aperture exposing the substrate therethrough. The ground clearance may be used to position the antenna away from other components to limit interference. While making antennas tunable is an important future option or current trend, difficulty lies in maximizing radiation efficiency by fully utilizing available volume, including a ground plane.

Various embodiments relate to relatively small, electrically short, aperture-tunable antennas, which are configured to provide good radiation efficiency by utilizing a ground plane with dual coupled resonators. Various embodiments may achieve good low-band radiation efficiency and may maintain a relatively fixed high-band performance. That is, the low-band may be tuned without disturbing the high-band performance. Various embodiments may result in a size reduction for the antenna. For example, various embodiments may be configured to occupy only a small corner volume of a device (e.g., a smart phone) and, thus, are suitable for MIMO/5G applications.

Exemplary embodiments as described herein include an electrically short, relatively small, tunable antenna device configured for covering a wide and stable high-band. The antenna device may include dual resonators including a tunable loop resonator and a monopole resonator, each of which being configured to contribute to antenna radiation. Further, the monopole resonator may be loaded via the tunable loop resonator.

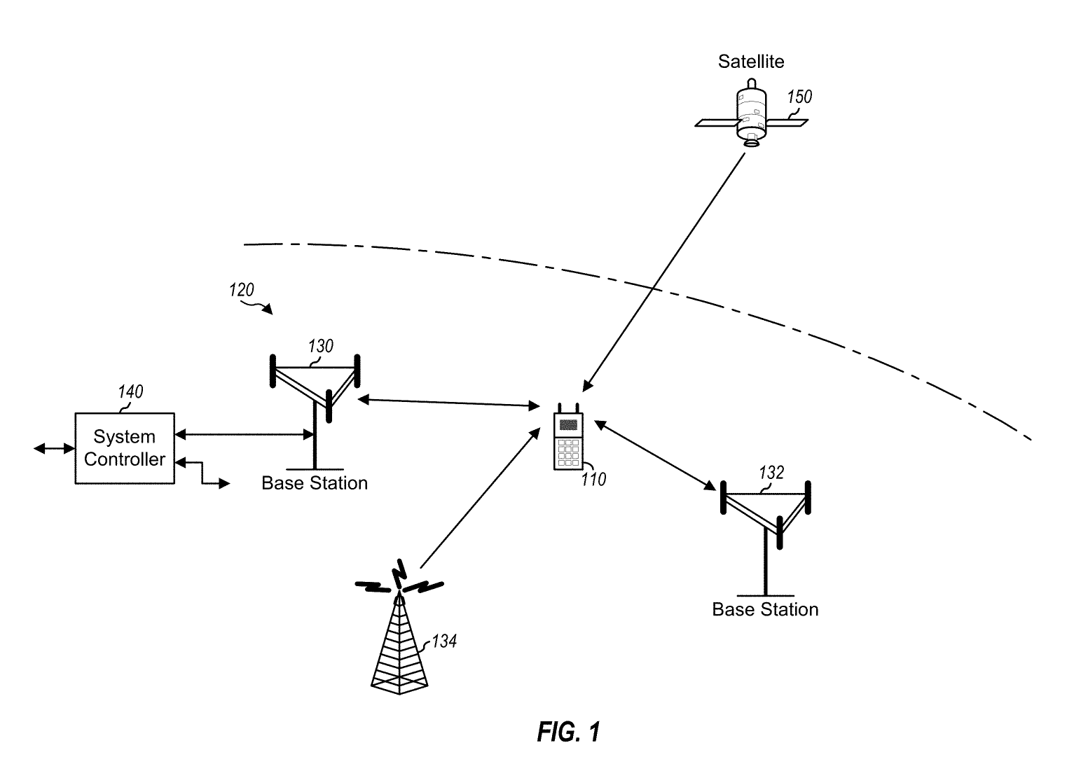

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

Wireless device 110 may support carrier aggregation, which is operation on multiple carriers. Carrier aggregation may also be referred to as multi-carrier operation. Wireless device 110 may be able to operate in low-band (LB) covering frequencies lower than 1000 megahertz (MHz), mid-band (MB) covering frequencies from 1000 MHz to 2300 MHz, and/or high-band (HB) covering frequencies higher than 2300 MHz. For example, low-band may cover 698 to 960 MHz, mid-band may cover 1475 to 2170 MHz, and high-band may cover 2300 to 2690 MHz and 3400 to 3800 MHz. Low-band, mid-band, and high-band refer to three groups of bands (or band groups), with each band group including a number of frequency bands (or simply, “bands”). Each band may cover 200 MHz, for example and may include one or more carriers. Each carrier may, for example cover 20 MHz in LTE. LTE Release 11 supports 35 bands, which are referred to as LTE/UMTS bands and are listed in 3GPP TS 36.101. Wireless device 110 may be configured with up to five carriers in one or two bands in LTE Release 11.

In general, carrier aggregation (CA) may be categorized into two types—intra-band CA and inter-band CA. Intra-band CA refers to operation on multiple carriers within the same band. Inter-band CA refers to operation on multiple carriers in different bands.

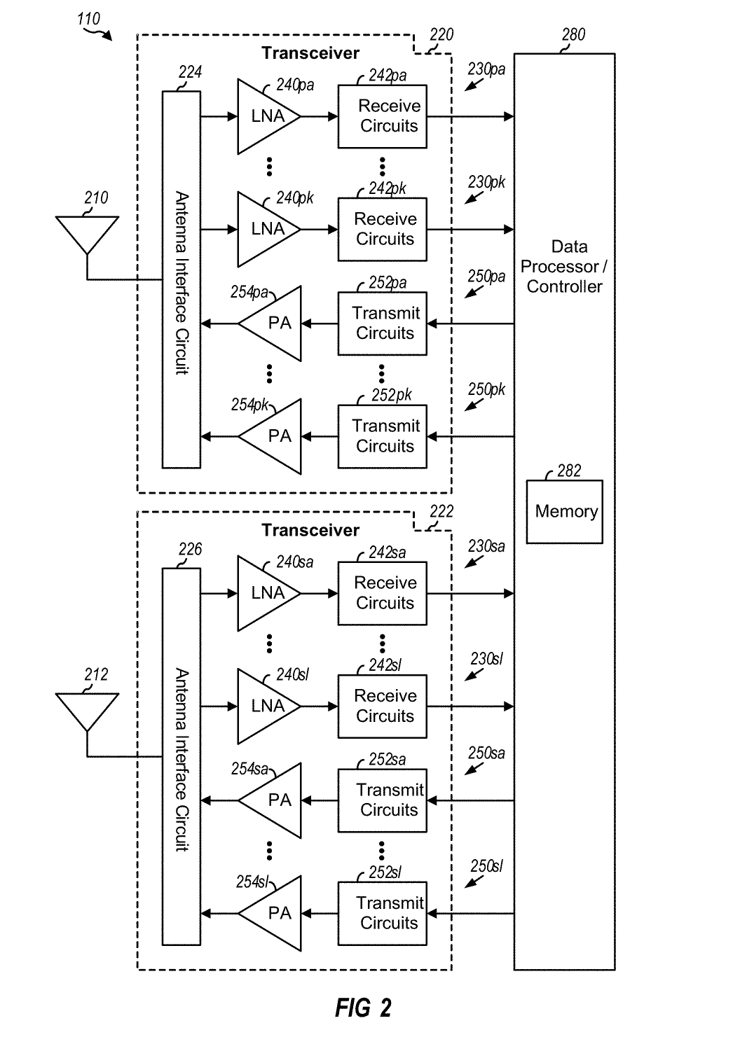

FIG. 2 shows a block diagram of an exemplary design of wireless device 110 in FIG. 1. In this exemplary design, wireless device 110 includes a transceiver 220 coupled to a primary antenna 210, a transceiver 222 coupled to a secondary antenna 212, and a data processor/controller 280. Transceiver 220 includes multiple (K) receivers 230pa to 230pk and multiple (K) transmitters 250pa to 250pk to support multiple frequency bands, multiple radio technologies, carrier aggregation, etc. Transceiver 222 includes a plurality of receivers 230sa to 230sl and a plurality of transmitters 250sa to 250sl to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes a low noise amplifier (LNA) 240 and receive circuits 242. For data reception, antenna 210 receives signals from base stations and/or other transmitter stations and provides a received RF signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in a similar manner as receiver 230pa.

In the exemplary design shown in FIG. 2, each transmitter 250 includes transmit circuits 252 and a power amplifier (PA) 254. For data transmission, data processor 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via antenna 210. Each remaining transmitter 250 in transceivers 220 and 222 may operate in a similar manner as transmitter 250pa.

FIG. 2 shows an exemplary design of receivers 230 and transmitters 250. A receiver and a transmitter may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 within transceivers 220 and 222 may be implemented on multiple IC chips. The circuits in transceivers 220 and 222 may also be implemented in other manners.

Data processor/controller 280 may perform various functions for wireless device 110. For example, data processor 280 may perform processing for data being received via receivers 230 and data being transmitted via transmitters 250. Controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs. Wireless device 110 may support CA and may (i) receive multiple downlink signals transmitted by one or more cells on multiple downlink carriers at different frequencies and/or (ii) transmit multiple uplink signals to one or more cells on multiple uplink carriers.

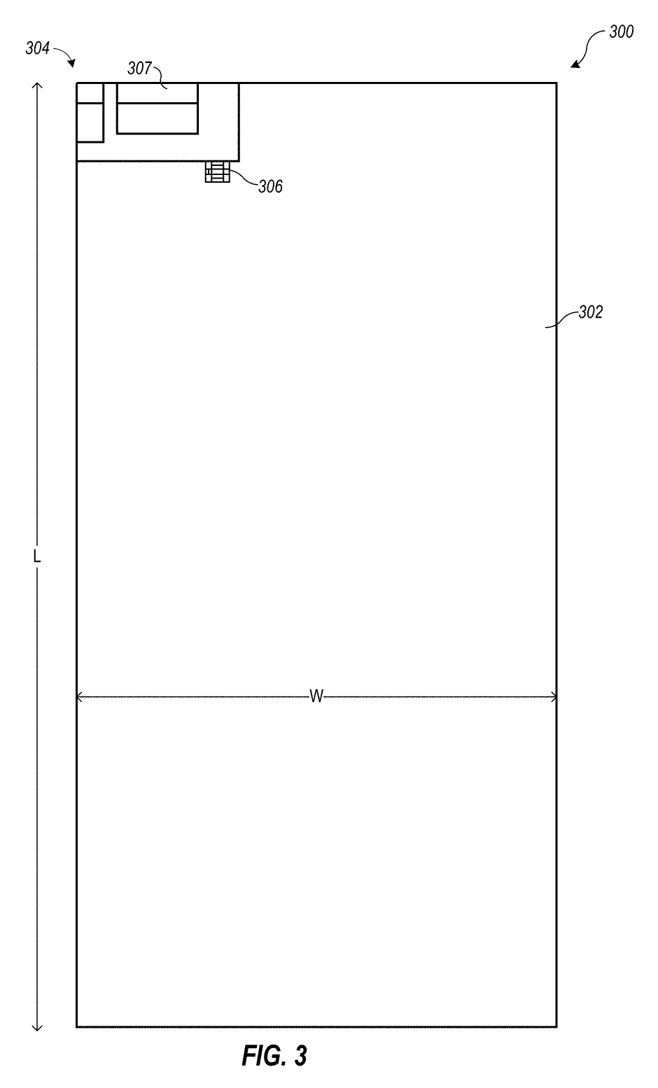

FIG. 3 illustrates a device 300, in accordance with an exemplary embodiment of the present disclosure. Device 300 includes a ground plane 302, which may comprise, for example, a printed circuit board (PCB) ground, an antenna device 304, an antenna feed 306, and a substrate 307. The antenna feed is a location connecting the antenna device to an RF circuit (not shown). As a non-limiting example, ground plane 302 may comprise a width W of substantially 62 millimeters and a length L of substantially 112 millimeters. As described more fully below, antenna device 304 may include dual resonators.

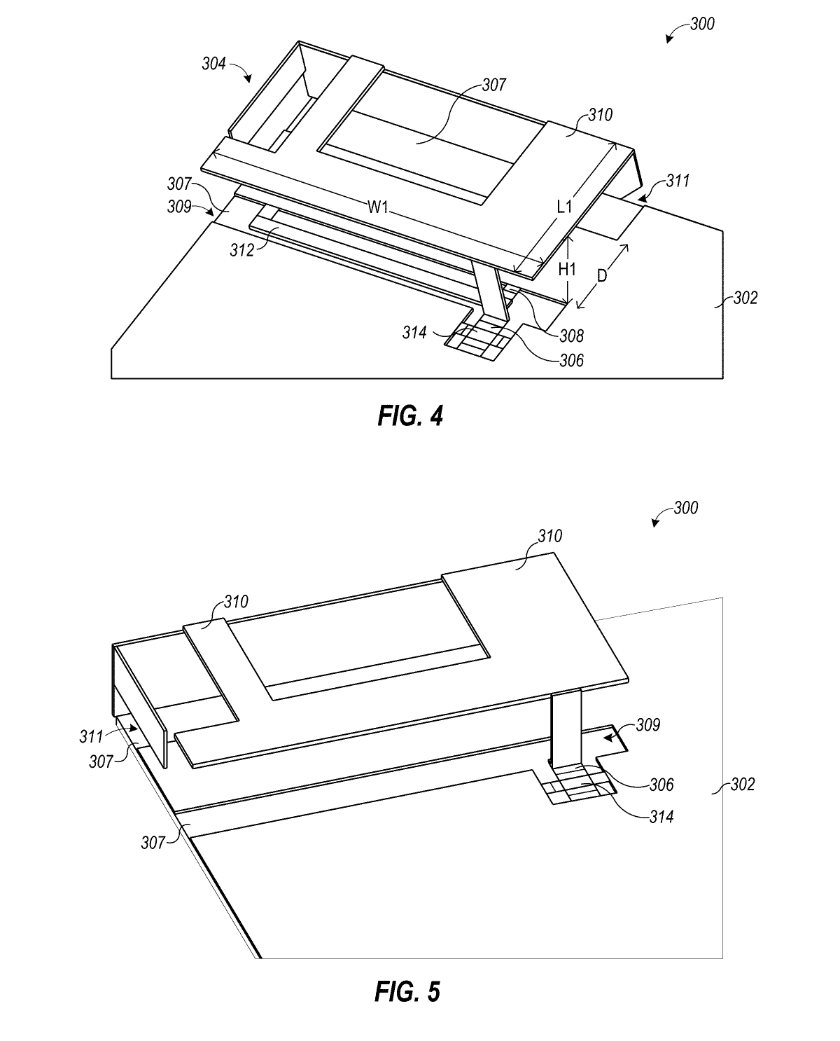

FIG. 4 is another illustration of device 300 including ground plane 302, antenna device 304, antenna feed 306, and substrate 307, which includes two portions exposed through apertures 309 and 311 in ground plane 302. As a non-limiting example, antenna device 304 may comprise a width W1 of substantially 21 millimeters, a length L1 of substantially 10 millimeters, and a height H1 of substantially 4 millimeters. Further, apertures 309 and 311 may be separated by a distance D, which may comprise, for example only, substantially 5 millimeters.

As noted above, antenna device 304 includes dual resonators. More specifically, antenna device 304 comprises a short monopole resonator 310 positioned adjacent or coupled to substrate 307 (e.g., an edge of substrate 307) and adjacent aperture 311. In other words, the antenna device 304 is in close proximity to the substrate 307 such that the electrical field from the radiator of the antenna device 304 propagates to the substrate 307. Further, antenna device 304 comprises a tunable loop resonator 312 positioned within aperture 309 and coupled to substrate 307. Antenna device 304 further includes a tuner 308 and a matching circuit 314. Short monopole resonator 310 and tunable loop resonator 312 may comprise any suitable material, such as, for example only, copper.

As will be appreciated by a person having ordinary skill in the art, traditional long antennas are optimized for low-band radiation, while electrically short antennas are suited for high-band radiation. Tunable loop resonator 312, which utilizes ground plane 302 to load and tune monopole resonator 310, may improve low-band radiation. Both short monopole resonator 310 and tunable loop resonator 312 are configured to resonate and, thus, optimal low-band and high-band radiation performance may be achieved. Antenna device 304 utilizes ground plane 302 as a part of the antenna radiator. Stated another way, ground plane 302 may be configured to radiate during resonance of the tunable loop resonator 312.

Device 300 further includes spacing (e.g., a clearance area) between ground plane 302 and monopole resonator 310. Stated another way, ground plane 302 is spaced (e.g., vertically) from a portion of monopole resonator 310 in a direction perpendicular to ground plane 302 (e.g., monopole resonator 310 is positioned in a plane above and separate from the ground plane 302). This spacing may allow, for example, circuits and accessory components to be positioned adjacent (e.g., in close proximity but not touching) ground plane 302 and between short monopole resonator 310 and ground plane 302. It is noted that a size of ground plane 302 may be modified (e.g., increased). Further, a position of ground plane 302 may be adjusted per design requirements.

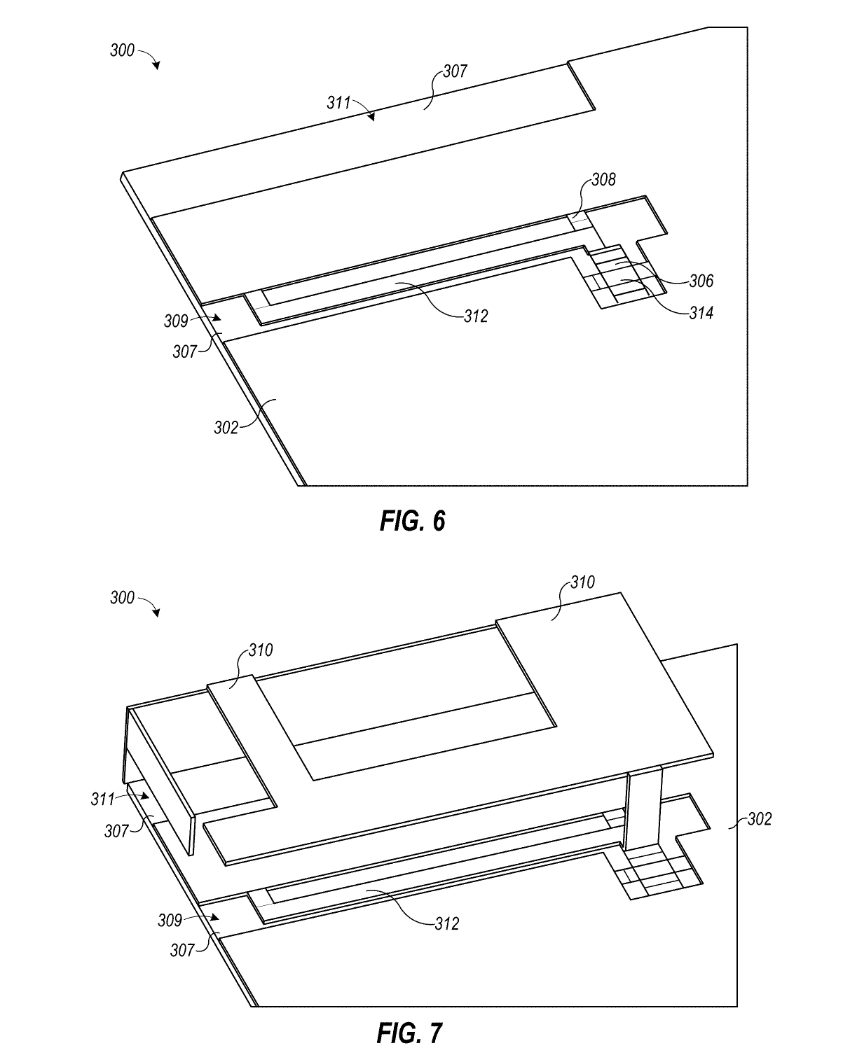

For ease of illustration and understanding, FIGS. 5-7 illustrate portions of device 300. FIG. 5 illustrates a portion of device 300 including short monopole resonator 310, ground plane 302, antenna feed 306, substrate 307, and matching circuit 314. FIG. 6 depicts another portion of device 300 including substrate 307, tunable loop resonator 312, tuner 308, antenna feed 306, and matching circuit 314. FIG. 7 illustrates device 300 including short monopole resonator 310 and tunable loop resonator 312. As shown in FIG. 7, tunable loop resonator 312 is in the same layer as the ground plane, which may comprise an electrical conductor such as copper, for example, on the substrate. The substrate may comprise an electrical insulator material such as a glass-reinforced epoxy laminated sheet (FR-4), for example, and may be in the form of a printed circuit board (PCB) in a layer adjacent to the ground plane.

Short monopole resonator 310 may be configured for a wide high-band. That is, the operating frequency bandwidth of the high-band may be increased. Tunable loop resonator 312 may be configured for radiation in low and high-bands. It is noted that tunable loop resonator 312 may function as a shunt loading to short monopole resonator 310, and tuning tunable loop resonator 312 may not impact high-band performance. As noted below, ground plane 302 may be configured to be a part of a radiating element of antenna device 304.

It is noted that short monopole resonator 310 may comprise a high-band radiator. Further, when short monopole resonator 310 is coupled to, or loaded with, tunable loop resonator 312, short monopole resonator 310 may also comprise a low-band radiator. Stated another way, when coupled to, or loaded with, tunable loop resonator 312, short monopole resonator 310 may be configured for both high-band and low-band radiation. It is further noted that in addition to being configured for low-band operation, tunable loop resonator 312 may contribute to high-band radiation (e.g., tunable loop resonator 312 may be also be configured for mid-band and high-band operation).

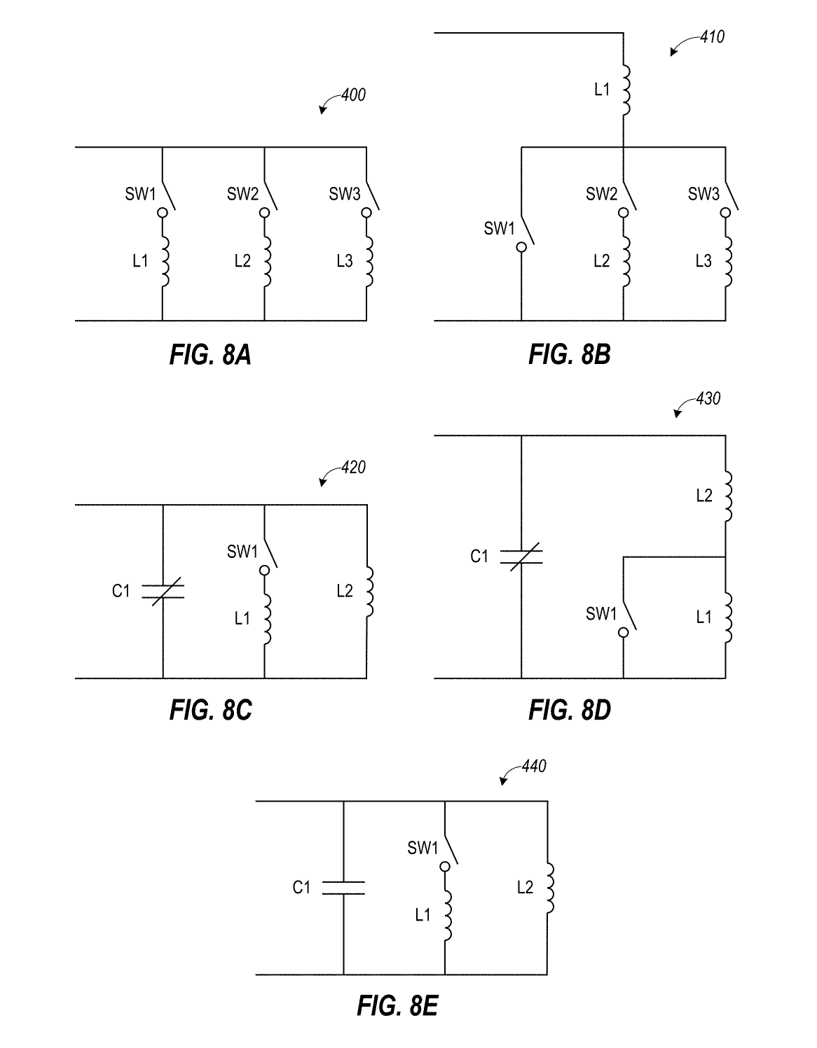

In various embodiments, a tuner (e.g., tuner 308) may be positioned within antenna device 304, on an extruded ground strip line. Further, a position of tuner 308 may be shifted along tunable loop resonator 312. Tuner 308 may comprise any suitable tuning circuitry. For example, tuner 308 may comprise tuning circuits including a bank of RF switches connected with inductors, or a combination of a tunable capacitor and a switch. FIGS. 8A-8E illustrate example tuning circuits of tuner 308. The tuner 308 may include multiple stages for tuning the antenna device 304. The multiple stages may be provided for example, by including additional switches or tunable capacitors. The addition of switches provides more stages for greater tunability of the antenna device 304. By including tunable capacitors, the number of switches can be reduced.

FIG. 8A illustrates a tuning circuit 400 including switches SW1-SW3 and inductors L1-L3. In this embodiment, switch SW1 is coupled in series with inductor L1, switch SW2 is coupled in series with inductor L2, and switch SW3 is coupled in series with inductor L3. As will be appreciated, via one or more of switches SW1-SW3, an inductance of tuning circuit 400 may be adjusted. Further, FIG. 8B depicts a tuning circuit 410 including switches SW1-SW3 and inductors L1-L3. In this embodiment, inductor L1 is coupled to each of switches SW1, SW2, and SW3. Switch SW2 is further coupled to inductor L2 and switch SW3 is coupled to inductor L3. As will be appreciated, via one or more of switches SW1-SW3, an inductance of tuning circuit 410 may be adjusted.

FIG. 8C depicts a tuning circuit 420 including switch SW1, inductors L1 and L2, and variable capacitor C1. By way of example only, variable capacitor C1 may have a capacitance that varies between substantially 0 and 1.875 Pico Farad. As will be appreciated, an inductance of tuning circuit 420 may be adjusted via switch SW1, and a capacitance of tuning circuit 420 may be adjusted via variable capacitor C1. FIG. 8D depicts another tuning circuit 430 including switch SW1, inductors L1 and L2, and variable capacitor C1, which, as noted above, may have a capacitance that varies between substantially 0 and 1.875 Pico Farad. Of course, the capacitance values are merely exemplary and for ease of explanation, and other capacitance values and ranges may also be used. As will be understood, an inductance of tuning circuit 430 may be adjusted via switch SW1, and a capacitance of tuning circuit 430 may be adjusted via variable capacitor C1. FIG. 8E depicts a tuning circuit 440 including switch SW1, inductors L1 and L2, and fixed capacitor C1. As will be appreciated, an inductance of tuning circuit 440 may be adjusted via switch SW1. A layout similar to FIG. 8D, except with a fixed capacitor, is also contemplated, although not illustrated.

With reference again to FIG. 4, tuner 308 may be configured to adjust a resonant frequency of antenna device 304 (e.g., tunable loop resonator 312) in low-band from, for example only, 700 MHz to 960 MHz by using four states of tuning (e.g., 700-746 MHz, 745-787 MHz, 824-894 MHz, and 880-960 MHz). Further, the high-band may be fixed (e.g., the high-band may be undisturbed) from, for example, 1.7 GHz to 2.7 GHz or 1.7 GHz to 6 GHz. Of course, the low-band and high-band frequency ranges are merely for ease of explanation and non-limiting. Other frequency ranges may also be used for the high-band and the low-band.

Tuning (e.g., via tuner 308) may change the effective length of tunable loop resonator 312. Further, tuning may shunt load short monopole resonator 310. Adding inductance may reduce an overall electrical length and increase resonant frequency, while adding capacitance may increase the electrical length and decrease the resonance frequency. That is, adding inductance reduces electrical length because the current goes to ground quicker than when no inductor is included. On the other hand, adding a capacitor is equivalent to loading the antenna to the ground plane more than without the capacitor. Accordingly, the current goes to ground slower, increasing the electrical length. Because the antenna is longer, the resonance frequency is reduced. Note that depending on a position of tuner 308, tuning via a shunt inductor may more easily provide a fixed high-band because the high-band is sensitive to the capacitor. That is, the capacitor operates like a high pass filter shorting the high-band energy to the ground. Further, a tunable shunt capacitor may require a capacitance of less than, for example, 1.8 pF to obtain good high-band performance.

Tunable loop resonator 312 may utilize the RF ground (e.g., ground plane 302) and short monopole resonator 310 may utilize a frame of device 300 (e.g., a frame of a mobile telephone). Device 300 may be configured for full aperture radiation, which may provide good low-band radiation performance. Compared with devices that do not use a ground and a frame as a radiating element, device 300 may provide a 2-3 dB improvement at lower frequency.

The embodiments disclosed herein may be suitable for small antenna volume (e.g., 10 mm*21 mm*4 mm) with significant ground area proximate the antenna since the antenna may utilize the ground area as a part of the antenna element. Further, circuits and/or accessory components may be positioned on ground plane 302. In addition, various embodiments only require two slots (e.g., apertures 309 and 311) and, therefore, are suitable for housing devices of electronic devices (e.g., metal or plastic housing of a phone).

High-band (e.g., 1.7-2.7 GHz) is primarily generated by short monopole resonator 310, which may not be impacted by tuning the low-band (e.g., 700-960 MHz). The low-band is generated from tuner 308, short monopole resonator 310, and tunable loop resonator 312. Tuning of the low-band, however, is achieved by controlling tuner 308 (not short monopole resonator 310), thus, making it possible to have carrier aggregation at any low frequency band. In some embodiments, the resonators (e.g., short monopole resonator 310 and tunable loop resonator 312) may cover an extremely wide band (e.g., from 1.7 GHz to 6 GHz), making it possible for LTE-U application. Of course, the resonator frequency range is merely exemplary and non-limiting. Furthermore, the low-band and high-band frequency ranges in the exemplary embodiments above are merely for ease of explanation and non-limiting. Other frequency ranges may also be used for the high-band and the low-band. Antenna device 304 may be substantially insensitive to parasitic capacitance of tuner 308, which may be taken into consideration for design purposes.

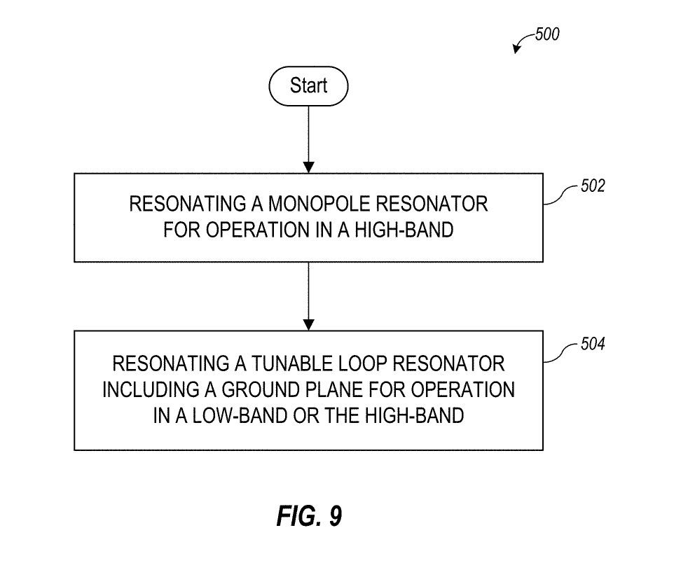

FIG. 9 is a flowchart illustrating a method 500, in accordance with one or more exemplary embodiments. Method 500 may include resonating a monopole resonator for operation in a high-band (depicted by numeral 502). Method 500 may also include resonating a tunable loop resonator including a ground plane for operation in at least one of a low-band and the high-band (depicted by numeral 504). Moreover, in some exemplary embodiments, the monopole resonator may be loaded with the loop resonator for desired low-band and wide high-band coverage (e.g., good radiation performance and high-band with increased operating frequency bandwidth).

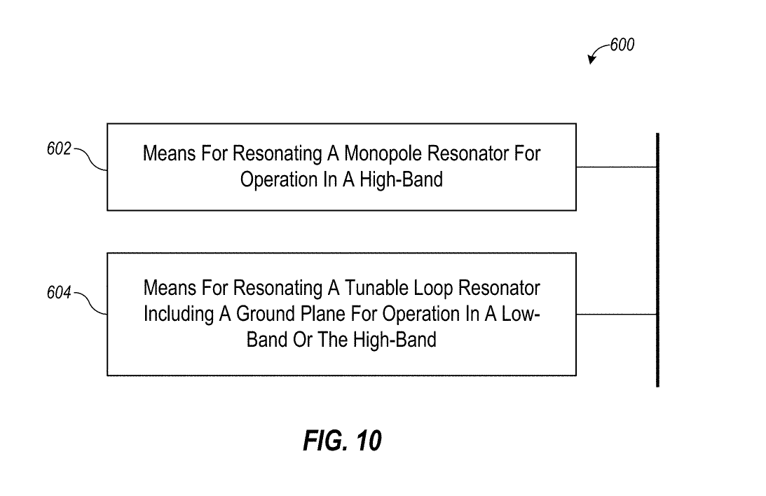

FIG. 10 shows an exemplary embodiment of an antenna device 600. For example, device 600 is suitable for use as device 300 (see FIG. 3). In an aspect, device 600 is implemented by one or more modules configured to provide the functions as described herein. For example, in an aspect, each module comprises hardware and/or hardware executing software.

Device 600 comprises a first module comprising means (602) for resonating a monopole resonator for operation in a high-band. For example, means 602 may comprise short monopole resonator 310 (see e.g., FIG. 4).

Device 600 also comprises a second module comprising means (604) for resonating a tunable loop resonator including a ground plane for operation in a low-band or the high-band. That is, the means for resonating may cause the ground plane (or portion thereof) to radiate during resonance of the tunable loop resonator such that the tunable loop resonator may contribute to low-band or high band coverage. In one example, means 604 may include tunable loop resonator 312 (see e.g., FIG. 4). Further, in some exemplary embodiments, device 600 may include means for loading the monopole resonator with the loop resonator for desired low-band and wide high-band coverage (e.g., good radiation performance and wide high-band bandwidth).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

It is noted that combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C.

The previous description of the disclosed exemplary embodiments is provided to enable any person skilled in the art to make or use the present disclosure. Various modifications to these exemplary embodiments will be readily apparent to those skilled in the art, and the generic principles defined herein may be applied to other embodiments without departing from the spirit or scope of the disclosure. Thus, the present disclosure is not intended to be limited to the exemplary embodiments shown herein but is to be accorded the widest scope consistent with the principles and novel features disclosed herein.

What is claimed is:

1. A device, comprising:
a ground plane positioned adjacent a substrate and including a first aperture and a second aperture exposing the substrate therethrough;
an antenna feed positioned in the first aperture;
a monopole resonator coupled to the antenna feed and having a portion positioned adjacent the substrate proximate the second aperture and another portion near the substrate and the ground plane in a direction perpendicular to the ground plane; and
a tunable loop resonator within the first aperture and coupled to the antenna feed and the ground plane.

2. The device of claim 1, further comprising a tuner coupled to the tunable loop resonator.

3. The device of claim 2, wherein the tuner is positioned within the first aperture.

4. The device of claim 2, wherein the tuner comprises at least one switch.

5. The device of claim 2, wherein the tuner comprises at least one inductor.

6. The device of claim 2, wherein the tuner comprises at least one capacitor.

7. The device of claim 6, wherein the at least one capacitor comprises one of a tunable capacitor or a fixed capacitor.

8. The device of claim 1 further comprising an impedance matching circuit coupled to the antenna feed.

9. The device of claim 8, wherein the impedance matching circuit is positioned within the first aperture.

10. The device of claim 1, wherein the monopole resonator is configured:
to operate in a high-band; and
to operate in a low-band using the tunable loop resonator.

11. The device of claim 1, wherein the tunable loop resonator is configured to operate in a plurality of low-bands, a mid-band, a high-band, or a combination thereof.

12. The device of claim 1, wherein the monopole resonator is coupled to or comprises a frame of an electronic device.

13. The device of claim 1, wherein the ground plane is configured to radiate during resonance of the tunable loop resonator.

14. The device of claim 1, wherein the tunable loop resonator is an aperture-tunable antenna.

15. The device of claim 1, wherein the tunable loop resonator is configured to load the monopole resonator via tuning of the tunable loop resonator.

16. The device of claim 1, wherein the portion of the monopole resonator is positioned adjacent at least one edge of the substrate proximate the second aperture.

17. A method, comprising:
resonating a monopole resonator for operation in a high-band; and
resonating a tunable loop resonator including a ground plane for operation in at least one of a low-band or the high-band.

18. The method of claim 17, further comprising loading the monopole resonator with the tunable loop resonator for low-band and high-band coverage.

19. A device, comprising:
means for resonating a monopole resonator for operation in a high-band; and
means for resonating a tunable loop resonator including a ground plane for operation in at least one of a low-band or the high-band.

20. The device of claim 19, further comprising means for tuning the tunable loop resonator to load the monopole resonator.

21. The device of claim 19, further comprising means for loading the monopole resonator with the tunable loop resonator for low-band and high-band coverage.
